(19) United States
(12) Patent Application Publication
(10) Pub. No.: US 2003/0037478 A1
(43) Pub. Date: Feb. 27, 2003

(54) Fishing lure device having buzz blade with trailing wing portions of different pitches

(76) Inventor: Danny L. Hisaw, Valliant, OK (US)

Correspondence Address: John R. Flanagan, FLANAGAN & FLANAGAN, P.O. Box 2629, Eugene,, OR, 97402, US

(21) Appl. No.: 09/935,071

(22) Filed: Aug. 22, 2001

(51) Int. Cl. A01K 79/02

(52) U.S. Cl. 43/17.1

(57) ABSTRACT

A fishing lure device includes a frame, a fishing hook and a buzz blade. The frame is configured to provide first and second frame members and a third frame member extending transversely between and interconnecting leading ends of the first and second frame members. The fishing hook is attached to a rear end of the first frame member. The buzz blade is rotatably mounted along the second frame member between front and rear ends thereof and has a leading portion and a pair of trailing portions bent relative to the leading portion to have different pitches and radii of curvature relative to one another such that as the buzz blade rotates about the second frame member upon the device being pulled through water the device moves with a side-to-side motion in a transverse relationship to the second frame member.

### BACKGROUND OF THE INVENTION

1. Field of the Invention

The present invention generally relates to fishing lure devices and, more particularly, is concerned with a fishing lure device having a rotatable buzz blade with trailing wing portions of different pitches that provides the device with a side-to-side swimming action.

2. Description of the Prior Art

It has long been the practice in the prior art to provide a fishing lure device with one or more buzz blades which rotate during movement of the fishing lure device through water. Representative examples of such devices are disclosed in U.S. Pat. No. 4,718,191 to Gentry, U.S. Pat. No. 4,793,089 to Long et al., U.S. Pat. No. 4,823,501 to Standish, Jr., U.S. Pat. No. 4,930,247 to Dubois and U.S. Pat. No. 5,146,706 to Hilliard. The lure device typically includes a body or frame made of a stiff resilient bendable wire and configured rectilinearly to provide first and second frame members which extend generally parallel to one another and a third frame member which extends transversely between and interconnects leading ends of the first and second frame members. A fishing hook is attached to a rear end of the first frame member and the buzz blade is rotatably mounted along the second frame member between front and rear ends thereof. The buzz blade typically have trailing wing portions which are bent at the same pitch relative to a leading flat portion of the blades.

While these prior art fishing lure devices appear to be satisfactory in use for the specific purposes for which they were designed, none of them seem to provide an optimum design in terms of the noise and motion that they can create so as to effectively attract fish. Consequently, a need still exists for the provision of an innovation in a fishing lure device which will enhance its capabilities over prior art fishing lure devices.

### SUMMARY OF THE INVENTION

The present invention provides a dual pitch buzz blade fishing lure device designed to satisfy the aforementioned need. The device of the present invention has a rotatable buzz blade with trailing wing portions of different pitches that provides the device with a side-to-side swimming action. The device also has a large slidable bead which is engageable by the outer tips of the wing portions of the buzz blade to make a clicking noise as the buzz blade rotates and the device thus moves in the side-to-side swimming-type action.

Accordingly, the present invention is directed to a fishing lure device which comprises: (a) a frame made of a stiff resilient bendable wire and configured rectilinearly to provide first and second frame members which extend generally parallel to one another and a third frame member which extends transversely between and interconnects leading ends of the first and second frame members so as to space apart the first and second frame members; (b) a fishing hook attached to a rear end of the first frame member; and (c) a buzz blade rotatably mounted along the second frame member between front and rear ends thereof, the buzz blade having a leading portion and a pair of trailing portions which extend from the leading portion and are bent at different pitches and have different radii of curvature relative to one another such that as the buzz blade undergoes rotating motion about the second frame member upon the device being pulled through water the device also moves with a side-to-side motion in a transverse relationship to the second frame member.

More particularly, the frame has a twisted loop portion formed at an integral merging of an end of the third frame member with the leading end of the first frame member. The device also includes a swivel element which is attached to the twisted loop portion and connectible with a fishing line so as to permit rotation of the frame without causing twisting of the fishing line. Also, a first bead is rotatably mounted on the first frame member adjacent to the buzz blade on the second frame member such that outer edges of the trailing portions of the buzz blade can strike the first bead and generate noise as the buzz blade undergoes rotational motion about the second frame member.

The device further includes a pair of spacer beads rotatably mounted on the second frame member such that each is positioned adjacent to a respective one of opposite front and rear ends of the buzz blade so as to prevent binding of the buzz blade on the second frame member. A counterweight element is disposed on a trailing end portion of the second frame member and spaced from the rear end of the buzz blade by one of the spacer beads.

These and other features and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

In the following detailed description, reference will be made to the attached drawings in which:

FIG. 1 is a perspective view of a fishing lure device of the present invention.

FIG. 2 is a top plan view of the device of FIG. 1.

FIG. 3 is a side elevational view of the device as seen along line 3--3 of FIG. 1.

FIG. 4 is a front elevational view of the device as seen along line 4--4 of FIG. 1.

FIG. 5 is an enlarged top plan view of a buzz blade of the device of FIG. 2.

FIG. 6 is a side elevational view of the buzz blade as seen along line 6--6 of FIG. 5.

FIG. 7 is another side elevational view of the buzz blade as seen along line 7--7 of FIG. 5.

### DETAILED DESCRIPTION OF THE INVENTION

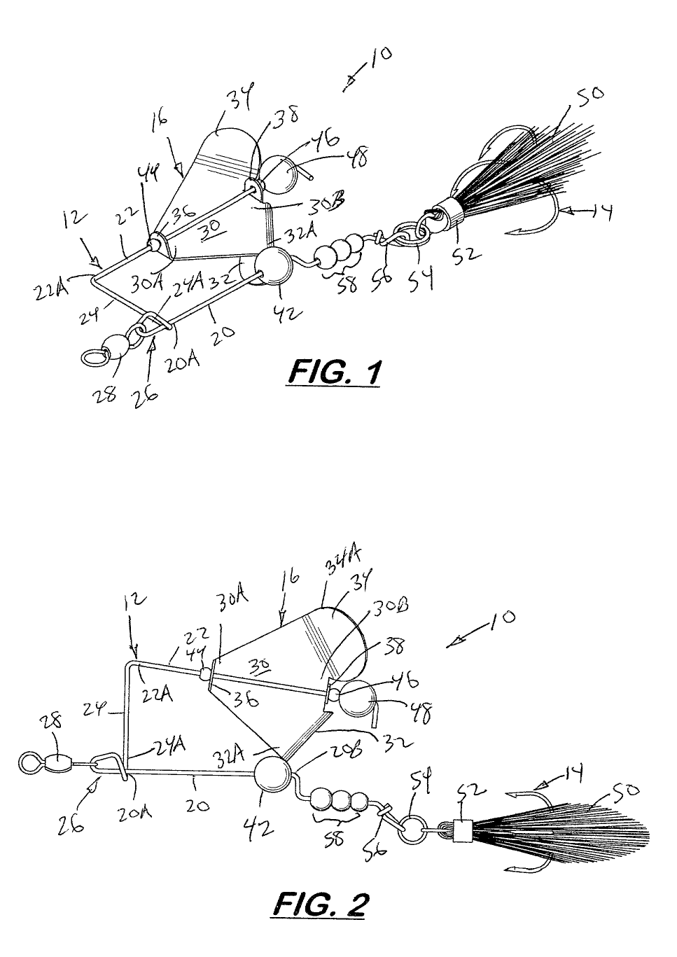

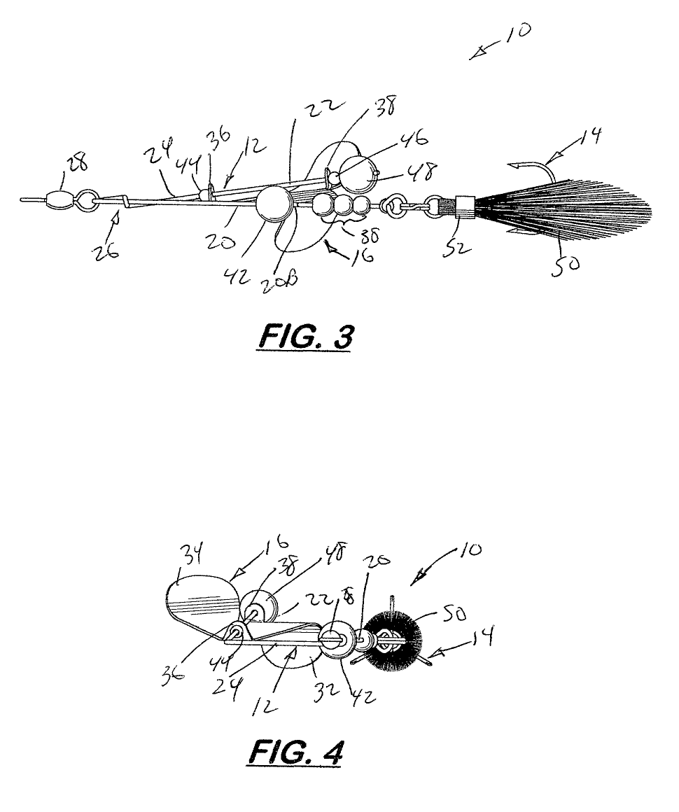

Referring to the drawings and particularly to FIGS. 1 to 4, there is illustrated a fishing lure device, generally designated 10, of the present invention. The fishing lure device 10 includes a body or frame 12, a fishing hook 14, a buzz blade 16 and a large bead 18 for generating noise, such as a clicking sound, due to impacts with the buzz blade 16.

The frame 12 of the device 10 preferably is made of a conventional stiff resilient bendable wire and formed in a generally U-shaped configuration so as to provide first and second frame members 20, 22 which extend generally parallel to one another and a third frame member 24 extending transversely between and interconnecting leading ends 20A, 22A of the first and second frame members 20, 22 so as to space apart the first and second frame members 20, 22 from one another.

The frame 12 also has a twisted loop portion 26 formed by and at an integral merging of an end 24A of the third frame member 24 with the leading end 20A of the first frame member 20. The device 10 also includes a swivel element 28 is attached to the twisted loop portion 26 and connectible with a fishing line (not shown) so as to permit rotation of the frame 12 and thus the device 10 without causing twisting of the fishing line.

The fishing hook 14 is attached to a rear end portion 20B of the first frame member 20 of the frame 12. The fishing hook 14 can take any suitable conventional form. One form which is preferred to be used by the device 10 is that of a treble hook, as illustrated in FIGS. 1-4.

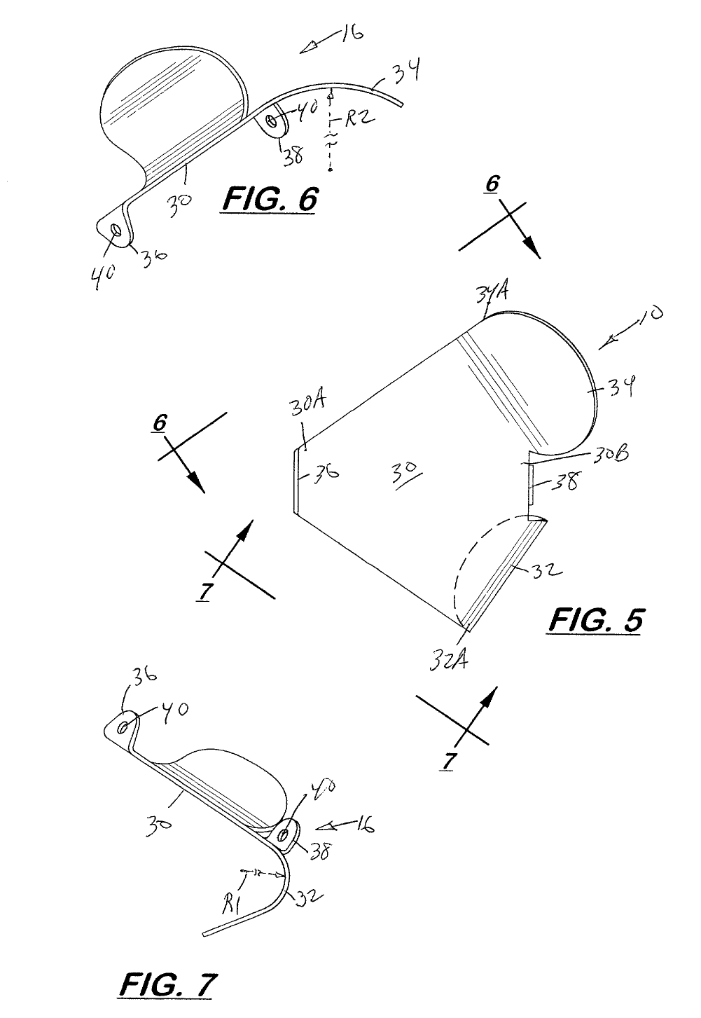

Referring now to FIGS. 1-7, the buzz blade 16 of the device 10 has a leading or main portion 30 preferably, although not necessarily, of a generally flat configuration and a pair of trailing wing portions 32, 34 which extend rearwardly from the leading portion 30. The buzz blade 16 also has a pair of front and rear tabs 36, 38 integrally formed on and projecting upright from front and rear ends 30A, 30B of the leading or main portion 30 of the buzz blade 16. The first frame member 20 extends through holes 40 defined in the front and rear tabs 36, 38 of the buzz blade 16 such that the buzz blade 16 is thereby mounted for rotational motion about and slidably motion along the first frame member 20 of the frame 12.

The trailing portions 32, 34 of the buzz blade 16 are bent in opposite directions from the leading portion 30. The trailing portions 32, 34 of the buzz blade 16 also are bent at different pitches relative to one another and have different radii R1, R2 of curvature relative to one another. The pitch of the one trailing portion 32 is characterized as being “tight” whereas the pitch of the other trailing portion 34 is characterized as being “loose” when compared to one another. The radius R1 of the one trailing portion 32 is shorter than the radius R2 of the other trailing portion 34. These relationships of the pitches and radii of the trailing portions 32, 34 of the buzz blade 16 cause the buzz blade 16 undergo a side-to-side swimming-type motion transverse to the second frame member 22 as the buzz blade 16 concurrently undergoes rotating motion about the second frame member 22 in response to the fishing lure device 10 being pulled through water on the end of the fishing line.

The device 10 also includes a first large bead 42 rotatably mounted on the first frame member 20 of the frame 12 and adjacent to the buzz blade 16 such that outer edges 32A, 34A of the trailing portions 32, 34 of the buzz blade 16 can strike the first bead 42 and thereby generate a noise, such as a clicking sound, for attracting the attention of a fish as the buzz blade 16 undergoes rotational motion about the second frame member 22. The device 10 further includes a pair of spacer beads 44, 46 rotatably mounted on the second frame member 22 such that each is positioned adjacent to a respective one of opposite front and rear ends 30A, 30B of the buzz blade 16 so as to prevent binding of the buzz blade 16 on the second frame member 22. Still further, a counterweight bead 48 is provided in the device 10 for providing better balance and helping the device 10 to stay in motion. The counterweight bead 48 is disposed on a trailing end portion 22A of the second frame member 22 and spaced from the rear end 30B of the buzz blade 16 by one of the spacer beads 46.

Furthermore, lure dressing hair 50 and a skirt band 52 can be provided in conjunction with the treble fishing hook 14. A split ring 54 and another twisted wire loop 56 are employed to connect the hook 14 to the rear end portion 20B of the first frame member 20. Also, a series or stack of three beads 58 of different diameter sizes are provided between the twisted wire loop 56 and two ninety-degree bends 58 in the rear end portion 20B of the first frame member 20 of the frame 12. These features all combine to help keep the hook 14 from getting tangled on the device 10.

It is thought that the present invention and its advantages will be understood from the foregoing description and it will be apparent that various changes may be made thereto without departing from the spirit and scope of the invention or sacrificing all of its material advantages, the form hereinbefore described being merely preferred or exemplary embodiment thereof.

I claim:

1. A fishing lure device, comprising:
(a) a frame made of a stiff resilient bendable wire and configured to provide first and second frame members and a third frame member which extends transversely between and interconnects leading ends of the first and second frame members so as to laterally space apart said first and second frame members from one another;
(b) a fishing hook attached to a rear end portion of said first frame member; and
(c) a buzz blade rotatably mounted on said second frame member and having a leading portion and a pair of trailing portions which are bent relative to and extend from said leading portion at different pitches relative to one another such that as the buzz blade undergoes rotating motion about the second frame member upon the device being pulled through water the device also moves with a side-to-side motion in a transverse relationship to the second frame member.

2. The device of claim 1 wherein said first, second and third frame members are provided in a U-shaped configuration.

3. The device of claim 1 wherein:
said frame has a twisted loop portion formed at integral merging of an end of said third frame member with said leading end of said first frame member; and
a swivel element is attached to said twisted loop portion and connectible with a fishing line so as to permit rotation of said frame without causing twisting of the fishing line.

4. The device of claim 1 further comprising:
a first bead rotatably mounted on said first frame member and adjacent to said buzz blade on said second frame member such that outer edges of said trailing portions of said buzz blade can strike said first bead and generate noise as said buzz blade undergoes rotational motion about said second frame member.

5. The device of claim 1 further comprising:
a pair of spacer beads rotatably mounted on said second frame member such that each is positioned adjacent to a respective one of opposite front and rear ends of said buzz blade so as to prevent binding of said buzz blade on said second frame member.

6. The device of claim 5 further comprising:
a counterweight element disposed on a trailing end portion of said second frame member and spaced from said rear end of said buzz blade by one of said spacer beads.

7. The device of claim 1 wherein said fishing hook is a treble hook.

8. A fishing lure device, comprising:
(a) a frame made of a stiff resilient bendable wire and configured to provide first and second frame members and a third frame member which extends transversely between and interconnects leading ends of the first and second frame members so as to laterally space apart said first and second frame members from one another;
(b) a fishing hook attached to a rear end portion of said first frame member; and
(c) a buzz blade rotatably mounted along said second frame member between front and rear ends thereof, said buzz blade having a leading portion and a pair of trailing portions which are bend relative to and extend from said leading portion so as to have different radii of curvature relative to one another such that as said buzz blade undergoes rotating motion about said second frame member upon said device being pulled through water said device also moves with a side-to-side motion in a transverse relationship to said second frame member.

9. The device of claim 8 wherein said first, second and third frame members are provided in a U-shaped configuration.

10. The device of claim 8 wherein:
said frame has a twisted loop portion formed at integral merging of an end of said third frame member with said leading end of said first frame member; and
a swivel element is attached to said twisted loop portion and connectible with a fishing line so as to permit rotation of said frame without causing twisting of the fishing line.

11. The device of claim 8 further comprising:
a first bead rotatably mounted on said first frame member and adjacent to said buzz blade on said second frame member such that outer edges of said trailing portions of said buzz blade can strike said first bead and generate noise as said buzz blade undergoes rotational motion about said second frame member.

12. The device of claim 8 further comprising:
a pair of spacer beads rotatably mounted on said second frame member such that each is positioned adjacent to a respective one of opposite front and rear ends of said buzz blade so as to prevent binding of said buzz blade on said second frame member.

13. The device of claim 12 further comprising:
a counterweight element disposed on a trailing end portion of said second frame member and spaced from said rear end of said buzz blade by one of said spacer beads.

14. The device of claim 8 wherein said fishing hook is a treble hook.

15. A fishing lure device, comprising:
(a) a frame made of a stiff resilient bendable wire and formed in a generally U-shaped configuration so as to provide first and second frame members which extend generally parallel to one another and a third frame member extending transversely between and interconnecting leading ends of the first and second frame members so as to space apart said first and second frame members from one another;
(b) a fishing hook attached to a rear end portion of said first frame member; and
(c) a buzz blade rotatably mounted along said second frame member and having a generally flat leading portion and a pair of trailing wing portions which extend from said leading portion and are bent at different pitches and have different radii of curvature relative to one another such that as said buzz blade undergoes rotating motion about said second frame member upon said device being pulled through water said device also moves with a side-to-side motion in a transverse relationship to said second frame member.

16. The device of claim 15 wherein:
said frame has a twisted loop portion formed at integral merging of an end of said third frame member with said leading end of said first frame member; and
a swivel element is attached to said twisted loop portion and connectible with a fishing line so as to permit rotation of said frame without causing twisting of the fishing line.

17. The device of claim 15 further comprising:
a first bead rotatably mounted on said first frame member and adjacent to said buzz blade on said second frame member such that outer edges of said trailing portions of said buzz blade can strike said first bead and generate noise as said buzz blade undergoes rotational motion about said second frame member.

18. The device of claim 15 further comprising:
a pair of spacer beads rotatably mounted on said second frame member such that each is positioned adjacent to a respective one of opposite front and rear ends of said buzz blade so as to prevent binding of said buzz blade on said second frame member.

19. The device of claim 18 further comprising:
a counterweight element disposed on a trailing end portion of said second frame member and spaced from said rear end of said buzz blade by one of said spacer beads.

20. The device of claim 15 wherein said fishing hook is a treble hook.
